(19) United States
(12) Patent Application Publication
(10) Pub. No.: US 2018/0056676 A1
(43) Pub. Date: Mar. 1, 2018

(54) LABEL CREATING METHOD, PROGRAM, TAPE PRINTING DEVICE, AND CABLE LABEL

(71) Applicant: SEIKO EPSON CORPORATION, Tokyo (JP)

(72) Inventor: Mikihiro KAJIHARA, Matsumoto-shi (JP)

(73) Assignee: SEIKO EPSON CORPORATION, Tokyo (JP)

(21) Appl. No.: 15/557,292

(22) PCT Filed: Feb. 3, 2016
(86) PCT No.: PCT/JP2016/000538

§ 371 Date: Sep. 11, 2017

(30) Foreign Application Priority Data
Mar. 12, 2015 (JP) 2015-049916
Mar. 12, 2015 (JP) 2015-049917

(51) Int. Cl. B41J 11/70; B41J 3/36; B41J 11/00; B41J 3/407

(52) U.S. Cl. CPC B41J 11/70; B41J 3/36; G06F 3/12; B41J 3/4075; B41J 11/003

(57) ABSTRACT

The tape printing device includes an information input unit that receives information; and a label creating unit that prints the information that is input by the information input unit on at least one of a first print region having a length L1 and a second print region having the length L1 adjacent to an elongated or strip-shaped print medium in a longitudinal direction, and that creates a cable label including a print region including the first print region and the second print region, a winding region having a length L2 adjacent to the print region in the longitudinal direction, and a sticking region having a length L3 adjacent to the winding region or the print region in the longitudinal direction.

used as a winding margin to be wound around a cable or the like, and the first print region and the second print region are used as a flag portion indicating identification information.

### CITATION LIST

### Patent Literature

PTL 1: Japanese Patent No. 3885790

### SUMMARY OF INVENTION

### Technical Problem

Incidentally, although a cable label illustrated in FIG. 7 of PTL 1 is a general arrangement, there is a problem that it is difficult to completely bond a flag portion and to remove the label (work of removing unnecessary labels). When misaligning and bonding the flag portion, there are many disadvantages such as adhesion of dust to the adhesive at a shifted portion and adhesion to other objects. In addition, there is a problem that work delay is generated by difficulty in removing labels. On the other hand, in the cable label illustrated in FIG. 8 of PTL 1, by making a folded portion between a first print region and a second print region, there is an advantage that it is easy to bond the flag portion, and the label can be easily removed by pulling the flag portion off. However, the cable label illustrated in FIG. 8 has a problem that the end portion of the flag portion tends to be peeled off, for example, in a case where the winding margin is insufficient with respect to a circumferential length of the cable.

Furthermore, in a case where the cable label as described above is used for business, there are many cases where a large number of labels are created before going sites and an installation work is performed by carrying the labels to the site. However, attempting to install a large number of cable labels is a considerable work burden on site. Therefore, there is a demand to reduce work burden on the site at least by performing preparations before going to the site. However, in the configuration of the cable label as described above, for example, a cable label illustrated in FIG. 8, there is only a way to make the label easier to use in the site by performing a folding operation between a first print region and a second print region.

In view of the above problem, an object of the present invention is to provide a cable label of which a flag portion is easy to be bonded and is difficult to be peeled off, to provide the cable label which can reduce the burden of installation work in the site, and to provide a label creating method, a program, and a tape printing device capable of creating the cable label.

### Solution to Problem

A label creating method of the present invention includes an information inputting step of inputting information; and a label creating step of printing the information that is input in the information inputting step on at least one of a first print region having a length L1 and a second print region having the length L1 adjacent to an elongated or strip-shaped print medium in a longitudinal direction, and of creating a cable label including a print region including the first print region and the second print region, a winding region having a length L2 adjacent to the print region in the longitudinal direction, and a sticking region having a length L3 adjacent to the winding region or the print region in the longitudinal direction.

A program of the present invention causes a computer to execute: an information inputting step of inputting information; and a print data generating step of printing the information that is input in the information inputting step on at least one of a first print region having a length L1 and a second print region having the length L1 adjacent to an elongated or strip-shaped print medium in a longitudinal direction, and for generating print data to create a cable label including a print region including the first print region and the second print region, a winding region having a length L2 adjacent to the print region in the longitudinal direction, and a sticking region having a length L3 adjacent to the winding region or the print region in the longitudinal direction.

A tape printing device of the present invention includes an information input unit that receives information; and a label creating unit that prints the information that is input by the information input unit on at least one of a first print region having a length L1 and a second print region having the length L1 adjacent to an elongated or strip-shaped print medium in a longitudinal direction, and that creates a cable label including a print region including the first print region and the second print region, a winding region having a length L2 adjacent to the print region in the longitudinal direction, and a sticking region having a length L3 adjacent to the winding region or the print region in the longitudinal direction.

The present invention creates the cable label including the print region including the first print region and the second print region which are adjacent to each other in the longitudinal direction of the print medium, the winding region adjacent to the print region, and the sticking region adjacent to the winding region or the print region. As described above, since the first print region and the second print region which become a flag portion are provided adjacent to each other, it is possible to easily attach the flag portion by folding the label according to a boundary position. In addition, by using the sticking region as an adhesion margin which adheres to the flag portion or the winding region by being overlapped therewith, it is possible to make it difficult for the cable label to peel off.

“Adjacent” means that they are adjacent to each other, that is, there is no other region between them. That is, in the print region, since the first print region and the second print region are provided adjacent to each other and the winding region is adjacent to the print region, arrangements of the print region and the winding region are any one of “the first print region, the second print region, and the winding region”, and “the winding region, the first print region, and the second print region”. In addition, since the sticking region is adjacent to the winding region or the print region, arrangements of the print region, the winding region, and the sticking region are any one of “the first print region, the second print region, the winding region, and the sticking region”, “the sticking region, the winding region, the first print region, and the second print region”, “the sticking region, the first print region, the second print region, and the winding region”, and “the winding region, the first print region, the second print region, and the sticking region”. The arrangement of the first print region and the second print region can be changed.

In addition, the cable label may be created by cutting the elongated print medium in a width direction, and may be created by using a cut label (strip-shaped print medium). In the latter case, the cut label in which the print region, the winding region, and the sticking region are partitioned in advance may be used, and a boundary mark indicating the boundary of each region may be printed on a fixed-length cut label in which each region is not partitioned.

The label creating method further includes an editing step of designating each of lengths of the length L1, the length L2, and the length L3, in which in the label creating step, the print medium is cut to be a label length (2L1+L2+L3) of the cable label.

According to the configuration of the present invention, lengths of the print region, the winding region, and the sticking region can be arbitrarily set according to the thickness of the cable, the number of cables, the user's preference, and the like.

In the label creating method, in the label creating step, the length L3 is variably set according to a tape width of the print medium.

According to the configuration of the present invention, the sticking region can be set to an appropriate length (can maintain effect of preventing peeling while eliminating waste of print medium) corresponding to the tape width of the print medium. In addition, a user can omit the labor of inputting a length of the sticking region.

In the label creating method, in the label creating step, each boundary mark is printed on boundaries of the first print region, the second print region, the winding region, and the sticking region.

According to the configuration of the present invention, since the boundary mark is printed, a user can distinguish each region. In addition, since a bending position of the flag portion can be checked, it is possible to accurately bond the first print region and the second print region.

The label creating method further includes an arrangement selecting step of selecting arrangements of the print region, the winding region, and the sticking region from a plurality of options, in which in the label creating step, the cable label is created based on a selected result of the arrangement selecting step.

According to the configuration of the present invention, it is possible to arbitrarily select arrangement of each region according to preference and usage of a user.

The cable label of the present invention includes a print region including a first print region having a length L1 and a second print region having the length L1 adjacent to an elongated or strip-shaped print medium in which a printing layer and a release paper layer adhere to each other in a longitudinal direction, a winding region having a length L2 adjacent to the print region in the longitudinal direction, and a sticking region having a length L3 adjacent to the winding region or the print region in the longitudinal direction, in which boundary marks indicating boundaries of the first print region, the second print region, the winding region, and the sticking region are printed.

According to the configuration of the present invention, since the first print region and the second print region which become a flag portion are provided adjacent to each other, it is possible to easily bond the flag portion. In addition, by using the sticking region as an adhesion margin which adheres to the flag portion or the winding region by being overlapped therewith, it is possible to make it difficult for the cable label to peel off.

A label creating method of the present invention includes an information inputting step of inputting information; and a label creating step of printing information that is input in the information inputting step on at least one of a first print region having a length L1 and a second print region having the length L1 adjacent to an elongated or strip-shaped print medium in which a printing layer and a release paper layer adhere to each other in a longitudinal direction, and of creating a cable label including a print region including the first print region and the second print region, and a winding region having the length L2 adjacent to the print region in the longitudinal direction, in which in the label creating step, half cutting for cutting a boundary between the print region and the winding region in the release paper layer in a width direction is performed.

A program of the present invention causes a computer to execute an information inputting step of inputting information, and a print data generating step of printing the information that is input in the information input unit on at least one of a first print region having a length L1 and a second print region having the length L1 adjacent to an elongated or strip-shaped print medium in which a printing layer and a release paper layer adhere to each other in a longitudinal direction, and of generating print data to create a cable label including a print region including the first print region and the second print region, and a winding region having a length L2 adjacent to the print region in the longitudinal direction, in which the print data includes a half cutting instruction for cutting a boundary between the print region and the winding region in the release paper layer in the width direction.

A tape printing device of the present invention includes an information input unit that receives information; and a label creating unit that prints the information that is input in the information input unit on at least one of a first print region having a length L1 and a second print region having the length L1 adjacent to an elongated or strip-shaped print medium in which a printing layer and a release paper layer adhere to each other in a longitudinal direction, and that creates a cable label including a print region including the first print region and the second print region, and a winding region having a length L2 adjacent to the print region in the longitudinal direction, in which the label creating unit performs half cutting for cutting a boundary between the print region and the winding region in the release paper layer in the width direction.

According to the present invention, in the longitudinal direction of the print medium, the cable label including the print region including the first print region and the second print region which are adjacent to each other, and the winding region adjacent to the print region, in which a boundary between the print region and the winding region in the release paper layer is cut, is created. As described above, since half cutting is performed on the boundary between the print region and the winding region, it is possible to create the flag portion by bonding the first print region and the second print region in advance before going to the site. With this, since it is only necessary to wind the winding margin around the cable in the site, it is possible to greatly reduce a work burden.

“Adjacent” means that they are adjacent to each other, that is, there is no other region between them. That is, in the print region, since the first print region and the second print region are provided adjacent to each other and the winding region is adjacent to the print region, arrangements of the print region and the winding region are any one of “the first print region, the second print region, and the winding region”, and “the winding region, the first print region, and the second print region”. The arrangement of the first print region and the second print region can be changed.

In addition, the cable label may be created by cutting the elongated print medium in the width direction, and may be created by using the cut label (strip-shaped print medium). In the latter case, the cut label in which partitioning (half cut) is performed in advance between the print region and the winding region may be used, and the fixed-length cut label in which each region is not partitioned may be used.

The label creating method further includes an editing step of designating each of lengths of the length L1 and the length L2, in which in the label creating step, full cutting for cutting the printing layer and the release paper layer in the width direction to be a label length (2L1+L2) of the cable label is performed.

According to the configuration of the present invention, lengths of the print region and the winding region can be arbitrarily set according to the thickness of the cable, the number of cables, the user's preference, and the like.

In the label creating method, in the label creating step, half cutting for cutting a boundary between the first print region and the second print region in the release paper layer in the width direction is performed.

According to the configuration of the present invention, since the half cutting is performed on the boundary between the first print region and the second print region, the bending position of the flag portion can clearly indicate to the user and a folding operation can be easily set to the user.

In the label creating method, in the label creating step, the cable label having the sticking region of a length L3 adjacent to the winding region or the print region in the longitudinal direction is created.

According to the configuration of the present invention, by using the sticking region as an adhesion margin which adheres to the flag portion or the winding region by being overlapped therewith, it is possible to make it difficult for the cable label to peel off.

Since the sticking region is adjacent to the winding region or the print region, arrangements of the print region, the winding region, and the sticking region are any one of “the first print region, the second print region, the winding region, and the sticking region”, “the sticking region, the winding region, the first print region, and the second print region”, “the sticking region, the first print region, the second print region, and the winding region”, and “the winding region, the first print region, the second print region, and the sticking region”. The arrangement of the first print region and the second print region can be changed.

The label creating method further includes an editing step of designating each of lengths of the length L1, the length L2, and the length L3, in which in the label creating step, the full cutting for cutting the printing layer and the release paper layer in the width direction to be a label length (2L1+L2+L3) of the cable label is performed.

According to the configuration of the present invention, lengths of the print region, the winding region, and the sticking region can be arbitrarily set according to the thickness of the cable, the number of cables, the user's preference, and the like.

In the label creating method, in the label creating step, half cutting for cutting a boundary between the sticking region and the print region or the winding region in the release paper layer in the width direction is performed.

According to the configuration of the present invention, by performing the half cutting a boundary between the sticking region and the print region or the winding region, since it is possible to wind a winding margin around an object while leaving the release paper of a bonding margin, it is possible to make it more difficult for the cable label to peel off without weakening adhesive strength of the bonding margin.

A cable label of the present invention includes a print region including a first print region having a length L1 and a second print region having the length L1 adjacent to an elongated or strip-shaped print medium in which a printing layer and a release paper layer adhere to each other in a longitudinal direction, and a winding region having a length L2 adjacent to the print region in the longitudinal direction, in which a boundary between the print region and the winding region in the release paper layer is cut in the width direction.

According to the configuration, since half cutting is performed on the boundary between the print region and the winding region, it is possible to create the flag portion by bonding the first print region and the second print region in advance before going to the site. With this, since it is only necessary to wind the winding margin around the cable in the site, it is possible to greatly reduce a work burden.

### BRIEF DESCRIPTION OF DRAWINGS

FIG. 1 is a configuration diagram of a printing system according to an embodiment of the present invention.

FIG. 2 is a block diagram illustrating a hardware configuration of a PC.

FIG. 3 is a block diagram illustrating a hardware configuration of a printing device.

FIG. 4 is a block diagram illustrating a functional configuration of the printing system.

FIG. 5A is a diagram illustrating a created example of a cable label.

FIG. 5B is a diagram illustrating a created example of the cable label.

FIG. 6 is a diagram illustrating an example of a label edit screen.

FIG. 7A is a diagram illustrating a procedure for attaching the cable label to a cable.

FIG. 7B is a diagram illustrating a procedure for attaching the cable label to a cable.

FIG. 7C is a diagram illustrating a procedure for attaching the cable label to a cable.

FIG. 7D is a diagram illustrating a procedure for attaching the cable label to a cable.

FIG. 8A is a diagram illustrating a state where the cable label is attached to a cable.

FIG. 8B is a diagram illustrating a state where the cable label is attached to a cable.

FIG. 9 is a diagram illustrating an example of a bonding margin table according to Modification Example 1.

FIG. 10A is a diagram illustrating a created example of a cable label according to Modification Example 2.

FIG. 10B is a diagram illustrating a created example of the cable label according to Modification Example 2.

FIG. 11 is a block diagram illustrating a functional configuration of a tape printing device according to a second embodiment.

FIG. 12 is a block diagram illustrating a hardware configuration of a printing device according to a third embodiment.

FIG. 13 is a block diagram illustrating a functional configuration of the printing system.

FIG. 14A is a diagram illustrating a created example of the cable label.

FIG. 14B is a diagram illustrating a created example of the cable label.

FIG. 15 is a diagram illustrating an example of the label edit screen.

FIG. 16A is a diagram illustrating a procedure for attaching the cable label to a cable.

FIG. 16B is a diagram illustrating a procedure for attaching the cable label to a cable.

FIG. 16C is a diagram illustrating a procedure for attaching the cable label to a cable.

FIG. 16D is a diagram illustrating a procedure for attaching the cable label to a cable.

FIG. 16E is a diagram illustrating a procedure for attaching the cable label to a cable.

FIG. 16F is a diagram illustrating a procedure for attaching the cable label to a cable.

FIG. 17A is a diagram illustrating a created example of a cable label according to Modification Example 5.

FIG. 17B is a diagram illustrating a created example of the cable label according to Modification Example 5.

FIG. 18A is a diagram illustrating a created example of a cable label according to Modification Example 6.

FIG. 18B is a diagram illustrating the created example of the cable label according to Modification Example 6.

FIG. 19 is a block diagram illustrating a functional configuration of a tape printing device according to a fourth embodiment.

### DESCRIPTION OF EMBODIMENTS

Hereinafter, with reference to the drawings, an embodiment of a label creating method, a program, a tape printing device, and a cable label of the present invention will be described.

### First Embodiment

In the embodiment, a case where the label creating method is realized by a personal computer (hereinafter, referred to as “PC”) 2 in which an information input unit is provided, and a printing device 3A as a label creating unit is exemplified.

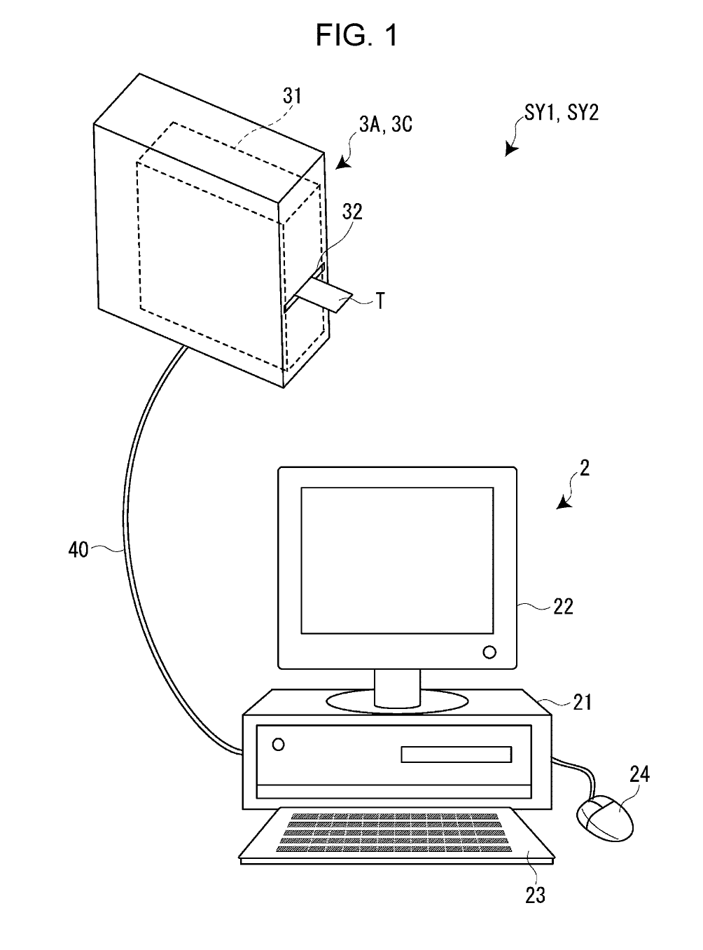

FIG. 1 is a configuration diagram of a printing system according to an embodiment of the present invention. As illustrated in FIG. 1, a printing system SY1 as the tape printing device includes the PC 2 and the printing device 3A that creates a label by performing printing on an elongated print medium (hereinafter, referred to as “printing tape T”).

The PC 2 includes general computer elements such as a PC main body 21, a display screen 22, a keyboard 23, and a mouse 24. In addition, the PC 2 communicates with the printing device 3A through a USB cable 40. The communication between the PC 2 and the printing device 3A is not limited to USB standard, but other standards such as Ethernet (registered trademark) may be used. In addition, a wireless communication standard such as Bluetooth (registered trademark) may be used.

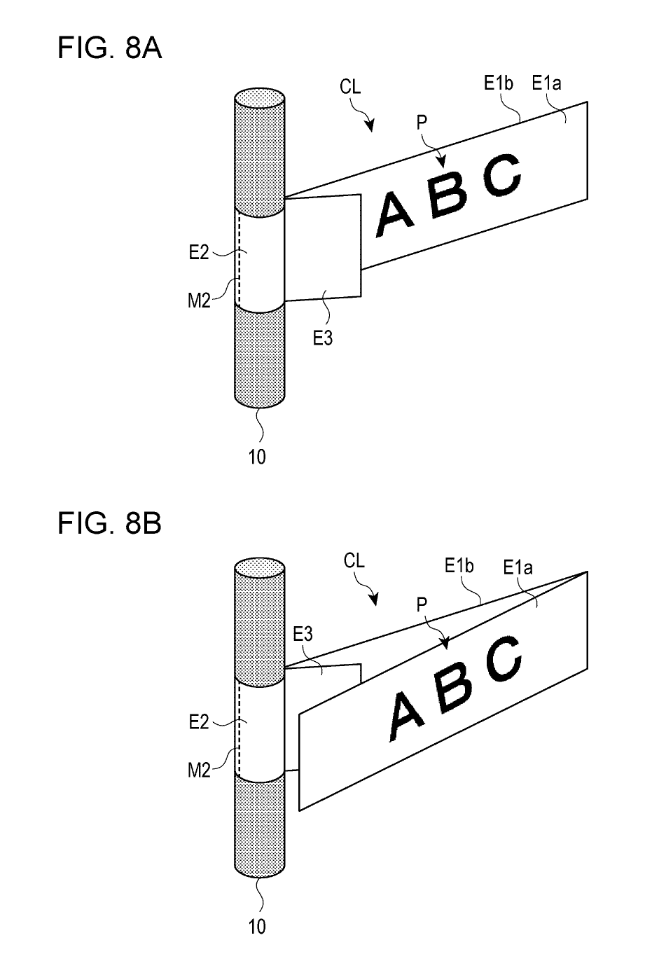

The printing device 3A in which a tape cartridge 31 accommodating a printing tape T and an ink ribbon is mounted performs a printing process and a cutting process while feeding the printing tape T from the tape cartridge 31, when print data is received from the PC 2. A printed portion of the printing tape T is discharged through a tape outlet 32 and used as a label after the cutting process. The printing device 3A of the embodiment can create a cable label CL used by being wound around an object such as a cable 10 (see FIG. 8A, FIG. 8B, and the like).

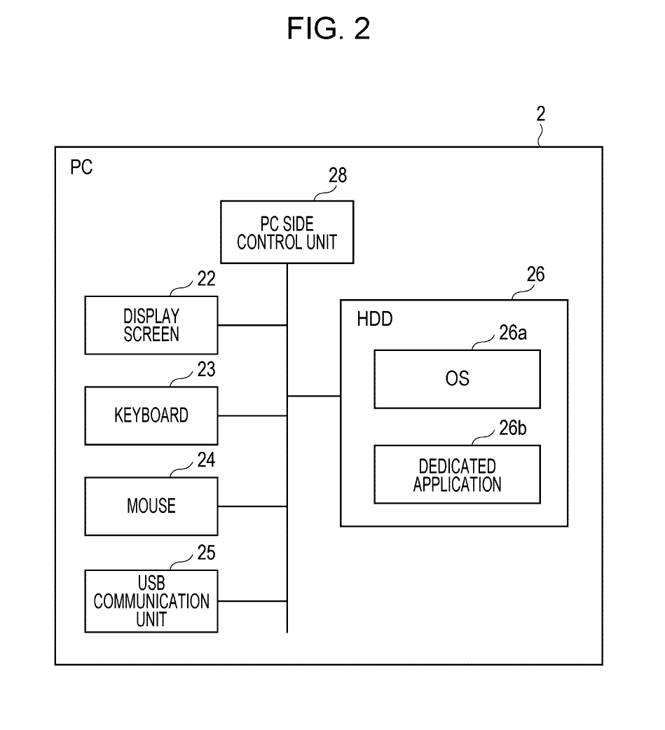

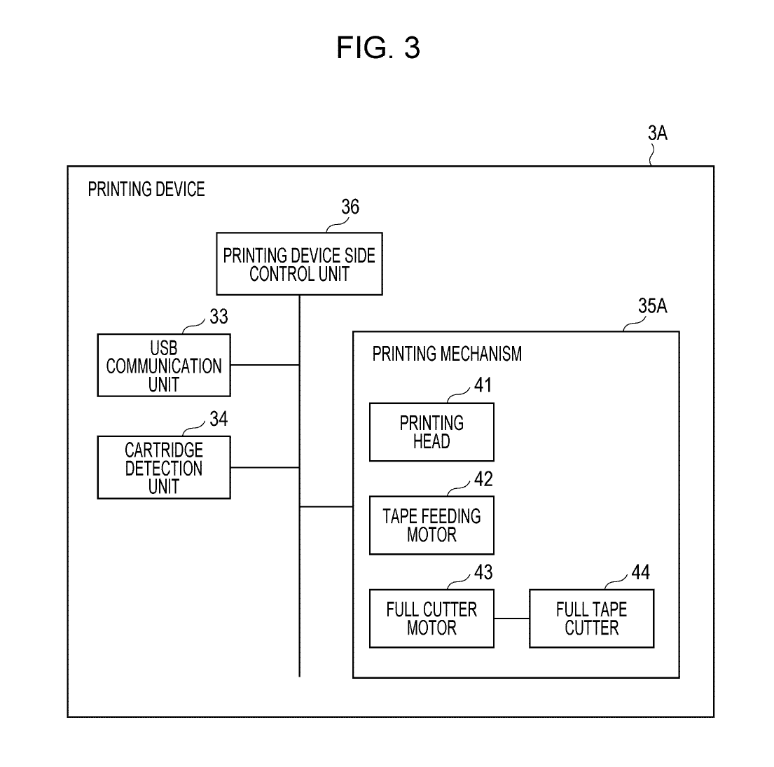

Next, with reference to FIG. 2 and FIG. 3, a hardware configuration of the PC 2 and the printing device 3A will be described. FIG. 2 is a block diagram of the PC 2. The PC 2 includes, as a hardware configuration, a USB communication unit 25, a hard disk drive (HDD) 26, and a PC side control unit 28 in addition to the display screen 22, the keyboard 23, and the mouse 24 illustrated in FIG. 1.

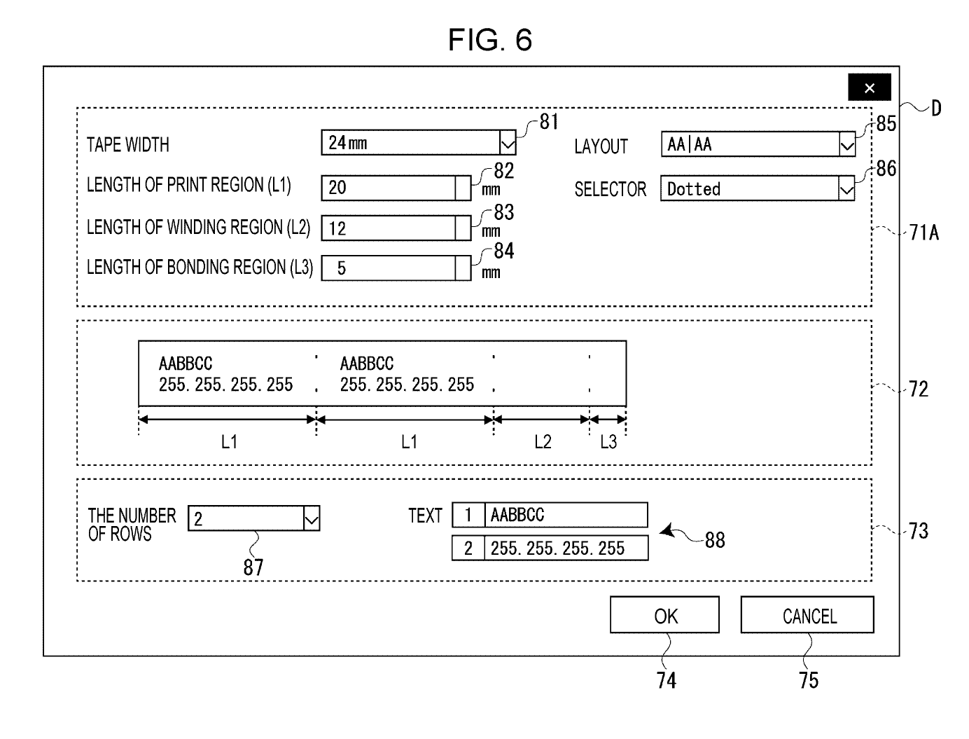

The display screen 22 displays various pieces of information such as a label edit screen D (see FIG. 6). The keyboard 23 and the mouse 24 are used for performing selection operations and editing operations of various options. The USB communication unit 25 performs communication with the printing device 3A based on a USB communication standard.

The HDD 26 stores an operating system (OS) 26a and the dedicated application 26b. The dedicated application 26b is an application for generating print data to be output to the printing device 3A. The label edit screen D is displayed as one function of the dedicated application 26b.

The PC side control unit 28 is realized by a central processing unit (CPU), a random access memory (RAM), and the like, and performs a print data generation process and communication control with the printing device 3A in cooperation with each of the above units (display screen 22 to HDD 26).

FIG. 3 is a block diagram of the printing device 3A. The printing device 3A includes, as a hardware configuration, a USB communication unit 33, a cartridge detection unit 34, a printing mechanism 35A, and a printing device side control unit 36.

The USB communication unit 33 communicates with the PC 2 by USB communication. The cartridge detection unit 34 detects tape information relating to the printing tape T accommodated in the tape cartridge 31. As the tape information, a tape width, the tape material, and the like of the printing tape T are detected. As a detection method, a method of reading a code image (bar code, two-dimensional code or the like) affixed or printed on the tape cartridge 31 or radio frequency identification (RFID), a method of detecting the presence or absence of one or more holes formed in the tape cartridge 31, and the like are conceivable. The detected tape information (for example, tape width) is reflected on preview display (see preview display region 72 in FIG. 6), options of the number of lines for inputting a text (see number of rows selection field 87 in FIG. 6), and the like.

The printing mechanism 35A includes a printing head 41, a tape feeding motor 42, a full cutter motor 43, and a full tape cutter 44. The printing head 41 is a thermal head, and performs printing by interposing the fed printing tape T and an ink ribbon between the printing head 41 and a platen roller (not illustrated). The tape feeding motor 42 transports the fed printing tape T toward the tape outlet 32 (see FIG. 1) from the printing head 41. The full cutter motor 43 drives the full tape cutter 44 to cut the printed portion of the printing tape T in a tape width direction in a state of stopping tape feeding temporarily. Although not specifically illustrated, the printing tape T has a structure in which a printing layer and a release paper layer adhere to each other through an adhesive layer. The full tape cutter 44 cuts the printing layer to the release paper layer.

The printing device side control unit 36 is realized by the CPU, the RAM, and the like, and performs communication control and print control with the PC 2 in cooperation with each of the above units (USB communication unit 33 to printing mechanism 35A). Specifically, when the tape cartridge 31 is mounted or when there is an inquiry from the PC 2, the tape information detected by the cartridge detection unit 34 is transmitted to the PC 2 through the USB communication unit 33. In addition, the print data is received from the PC 2 through the USB communication unit 33, the printing mechanism 35A is controlled based on the print data.

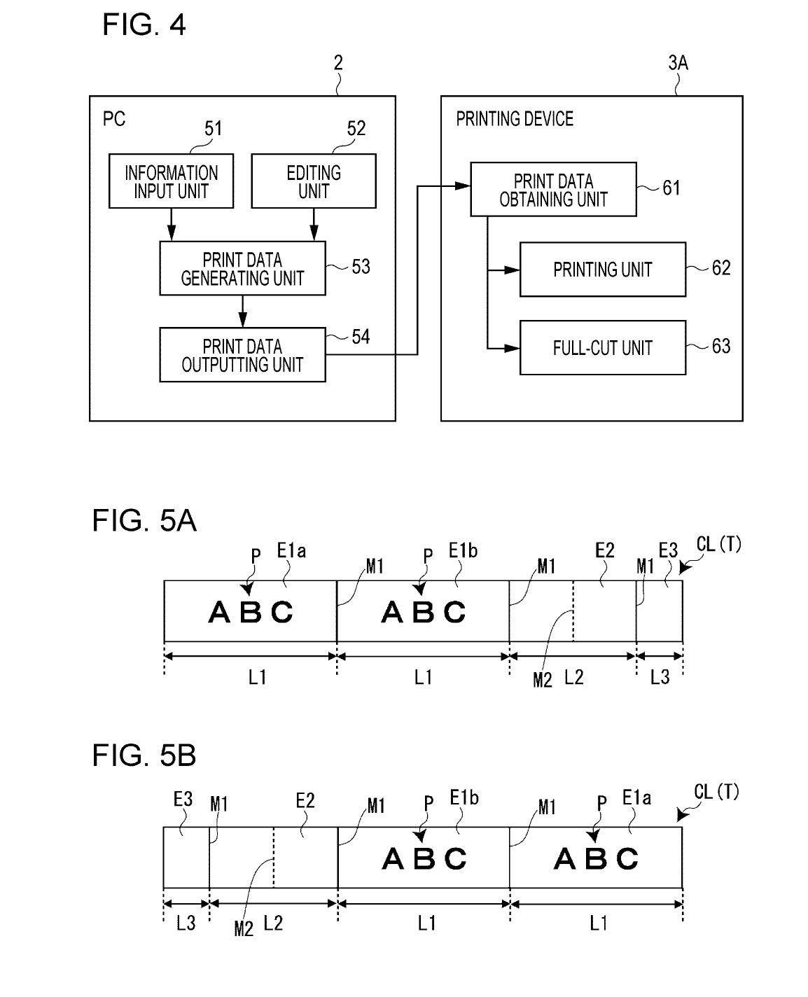

Next, with reference to FIG. 4, a functional configuration of the printing system SY1 will be described. The PC 2 includes, as a functional configuration, an information input unit 51, an editing unit 52, a print data generating unit 53, and a print data outputting unit 54. These are functions provided by mainly the dedicated application 26b (see FIG. 2). In addition, the printing device 3A includes, as a functional configuration, a print data obtaining unit 61, a printing unit 62, and a full-cut unit 63. A label creating step in the claims is realized by the print data generating unit 53, the print data outputting unit 54, the print data obtaining unit 61, the printing unit 62, and the full-cut unit 63.

The information input unit 51 receives information (text, image, or the like) to be printed on a print region E1 constituting a flag portion of the cable label CL. In the embodiment, although one or more lines of a text are input as information, an image such as a symbol and a mark may be inserted.

The editing unit 52 designates the lengths of the print region E1, a winding region E2, and a sticking region E3 (also referred to as regions E1, E2, and E3). The winding region E2 constitutes a winding margin to be wound around the cable 10. In addition, the sticking region E3 constitutes an adhesion margin that adheres to the flag portion by overlapping or interposing. In addition, the editing unit 52 performs layout designation of the print region E1, selection of a boundary mark M1 (selector) indicating boundaries of the respective regions E1, E2, and E3, or the like (see edit region 71A of FIG. 6).

The print data generating unit 53 generates the print data for creating the cable label CL. The print data includes an instruction for printing information that is input by the information input unit 51 on the print region E1 (first print region E1a and/or second print region E1b), an instruction for printing the boundary mark M1 on boundaries of respective regions E1, E2, and E3 based on the designation of the editing unit 52, an instruction for cutting a rear end of the cable label CL, or the like.

The print data outputting unit 54 outputs the print data generated by the print data generating unit 53 to the printing device 3A.

Here, a configuration (arrangement of respective regions E1, E2, and E3) of the cable label CL will be described. FIG. 5A is a diagram illustrating a created example of the cable label CL according to the embodiment. The cable label CL illustrated in FIG. 5A is a label of a label length (2L1+L2+L3) including the first print region E1a having a length L1 and the second print region E1b having the length L1 which are adjacent to each other in a longitudinal direction of the printing tape T, the winding region E2 having a length L2 adjacent to the second print region E1b, and the sticking region E3 having a length L3 adjacent to the winding region E2.

“Adjacent” means that they are adjacent to each other, that is, there is no other region between them. In addition, on the first print region E1a and the second print region E1b, the print image P (text “ABC” in example of FIG. 5A) is printed based on the information input by the information input unit 51, and on the boundaries of respective regions E1, E2, and E3, the boundary mark M1 (in example of FIG. 5A, solid line extending in width direction of printing tape T) is printed. Furthermore, on a central portion of the winding region E2 in the longitudinal direction, a reference mark M2 (in example of FIG. 5A, dotted line extending in width direction of printing tape T) which is a reference position at the time of winding the winding region E2 to the cable 10 is printed.

The arrangement of respective regions E1, E2, and E3 of the cable label CL is not limited to an arrangement illustrated in FIG. 5A. As illustrated in FIG. 5B, respective regions E1, E2, and E3 of FIG. 5A may be symmetrically arranged. That is, a configuration in which respective regions are provided adjacent to each other in the longitudinal direction of the printing tape T in an order of the print region E1, the winding region E2, and the sticking region E3 may be implemented.

Returning to the description of FIG. 4. The print data obtaining unit 61 of the printing device 3A obtains the print data from the PC 2. The printing unit 62 performs printing on the printing tape T based on the obtained print data. That is, the print image P, the boundary mark M1, and the reference mark M2 are printed on positions designated within each print data. In addition, the full-cut unit 63 cuts the printing layer and the release paper layer of the printing tape T in the width direction based on the obtained print data (to be length of label that is designated).

Next, with reference to FIG. 6, a screen configuration of the label edit screen D will be described. The label edit screen D includes the edit region 71A, the preview display region 72, an information input region 73, an OK button 74, and a cancel button 75. When the OK button 74 is selected, edit content of the label edit screen D is reflected on the print data. In addition, when the cancel button 75 is selected, the edit content of the label edit screen D becomes invalid. By selection of the OK button 74, a configuration in which the print data is output to the printing device 3A may be implemented.

The edit region 71A includes a tape width selection field 81 for selecting the tape width, a print region length selection field 82 for selecting the length L1 of the print region E1, a winding region length selection field 83 for selecting the length L2 of the winding region E2, a sticking region length selection field 84 for selecting the length L3 of the sticking region E3, a layout selection field 85 for selecting a layout of the print region E1, and a selector selection field 86 for selecting types of the boundary mark M1. The tape width selection field 81 may reflect the tape width detected in the printing device 3A by a predetermined operation, rather than selecting the tape width by the user.

For example, in a case where an option “AA|AA” is selected in the layout selection field 85, the same print image P is printed on the first print region E1a and the second print region E1b, in a case where an option “AA|BB” is selected, different print images P are printed on the first print region E1a and the second print region E1b. Therefore, in the latter case, there are provided two of the number of rows selection field 87 and a text input field 88 which will be described below. In the layout selection field 85, a writing direction of text (vertical writing/horizontal writing) may be selectable. In addition, in the selector selection field 86, in addition to the boundary mark M1 of the solid line illustrated in FIG. 5A and FIG. 5B and a boundary mark of two dots (of dot type) as illustrated in a label image of the preview display region 72, options such as a dotted line boundary mark and no boundary mark can be selected.

A label image on which an edit/input result of the edit region 71A and the information input region 73 is reflected is displayed on the preview display region 72. In addition, “L1”, “L2”, and “L3” indicate lengths of respective regions E1, E2, and E3, and correspond to symbols displayed on each field of the print region length selection field 82, the winding region length selection field 83, and the sticking region length selection field 84.

The information input region 73 includes the number of rows selection field 87 for selecting an input row of a text and the text input field 88 for inputting a text corresponding to each row. A row input field of the number of rows selected in the number of rows selection field 87 is displayed in the text input field 88. A text that is input in the text input field 88 is reflected on the label image of the preview display region 72 according to the input. In the tape width selection field 81 to the sticking region length selection field 84 in the edit region 71A, and the number of rows selection field 87 of the information input region 73, although each edit item is designated by selecting a desired option from a plurality of options, a numerical value may be directly input.

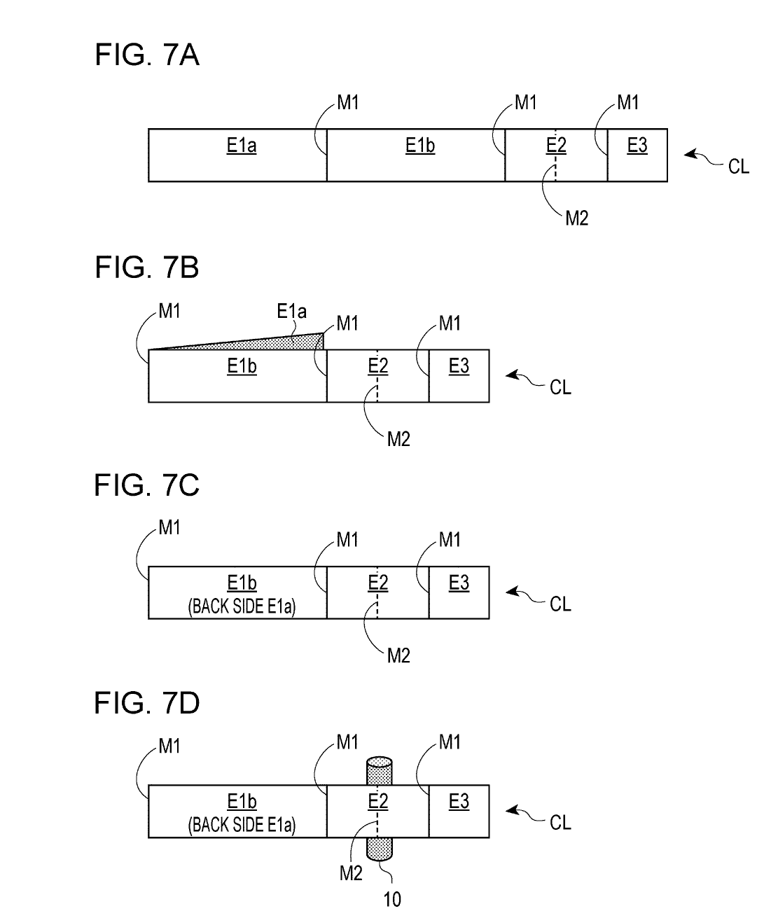

Next, with reference to FIG. 7A to FIG. 7D, and FIG. 8A and FIG. 8B, a procedure for attaching the cable label CL to the cable 10 will be described.

FIG. 7A illustrates the cable label CL in a state of being discharged from the printing device 3A. From this state, as illustrated in FIG. 7B, folding (folding operation) is performed by folding along the boundary mark M1 between the first print region E1a and the second print region E1b. Subsequently, as illustrated in FIG. 7C, a release paper of the cable label CL is peeled off and the folding portion is folded such that the adhesive layers of the first print region E1a and the second print region E1b are bonded to each other. Thus, as illustrated in FIG. 7D, a winding position on the cable 10 is determined with the reference mark M2 of the winding region E2 as a reference.

FIG. 8A illustrates a state where the winding region E2 is wound around the cable 10 from a state of FIG. 7D. In the state of FIG. 8A, the sticking region E3 adheres to the first print region E1a by being overlapped therewith, and the attachment of the cable label CL is completed.

After FIG. 7B, the winding region E2 is wound around the cable 10 without adhering the first print region E1a and the second print region E1b, and finally the sticking region E3 may be attached to be interposed between the first print region E1a and the second print region E1b (see FIG. 8B). According to this configuration, the print image P printed on the first print region E1a is not hidden by the sticking region E3.

As described above, since the cable label CL created by the printing system SY1 of the embodiment includes the sticking region E3 that adheres to the print region E1 by overlapping or interposing, there is an advantage that it is hardly peeled off as compared with a label not having the sticking region E3. In addition, since the first print region E1a and the second print region E1b which are the flag portions are provided adjacent to each other, there is also merit that a user can easily bond the flag portion.

In addition, since the boundary marks M1 are printed on the boundaries of respective regions E1, E2, and E3, and the reference mark M2 is printed on the central portion of the winding region E2, a user can grasp a folding position of the flag portion and an attachment position on the cable 10. Furthermore, in the label edit screen D, since lengths (L1, L2, and L3) of the print region E1, the winding region E2, and the sticking region E3 can be designated, the length of each of the regions E1, E2, and E3 can be arbitrarily set according to the thickness of the cable, the number of cables, user's preference, and the like.

Regardless of the above embodiment, the following modification examples can be adopted.

### Modification Example 1

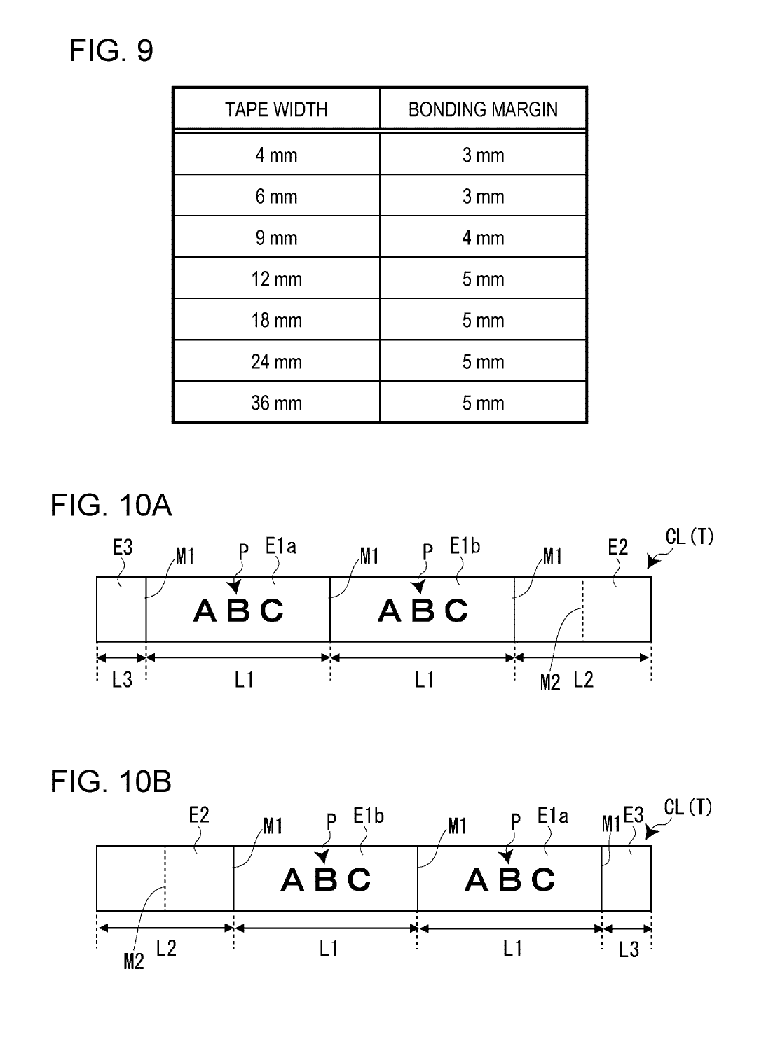

In the embodiment, lengths of respective regions E1, E2, and E3 are designated by the user, the length of the sticking region E3 (L3) may be variably set according to the tape width. In this case, a bonding margin table as illustrated in FIG. 9 is stored in the PC 2, and according to the tape width detected by the printing device 3A or the tape width designated by the user, values of the bonding margin table are set as the length (L3) of the sticking region E3.

According to the configuration, the sticking region E3 can be set to an appropriate length (can maintain effect of preventing peeling while eliminating waste of printing tape T) corresponding to the tape width of the printing tape T. In addition, the user can omit the labor of inputting the length (L3) of the sticking region E3.

a further modification example, it is possible to perform variable setting of the length of the print region E1 according to the input information (length of print image P in longitudinal direction), designation of the thickness (diameter or the like) and the number of the cables 10 by the user, variable setting of the length of the winding region E2 according to the designation, and the like. According to the configuration, it is possible to set the lengths of the print region E1 and the winding region E2 as an appropriate length, and it is possible to maintain the effect of making it difficult to peel off while eliminating the waste of printing tape T.

### Modification Example 2

In addition, in the embodiment, as illustrated in FIG. 5A and FIG. 5B, the cable label CL connected in the order of the print region E1, the winding region E2, and the sticking region E3 is created. However, as illustrated in FIG. 10A, the cable label CL connected in an order (regions E3, E1, and E2) of the sticking region E3, the print region E1 (first print region E1a+second print region E1b), and the winding region E2 may be created. In addition, as illustrated in FIG. 10B, respective regions E3, E1, and E2 of FIG. 10A may be symmetrically arranged. In these cases, the sticking region E3 is bonded by being overlapped with the winding region E2.

In addition, as a further modification example, the user may be able to select a desired arrangement from the arrangement of FIG. 5A, the arrangement of FIG. 5B, the arrangement of FIG. 10A, and arrangement of FIG. 10B (arrangement selecting step). According to the configuration, the arrangements of respective regions E1, E2, and E3 can be arbitrarily selected according to the preference and usage of the user.

### Modification Example 3

In addition, in the embodiment, although the cable label CL is created by cutting the elongated printing tape T, a cut label (strip-shaped print medium) that does not require cutting may be used. That is, the full-cut unit 63 may be omitted in the configuration of the printing device 3A illustrated in FIG. 4. The cut label means the printing tape T in which a fixed-length label having the first print region E1a, the second print region E1b, the winding region E2, and the sticking region E3 is formed in advance.

In this case, the cable label CL is created by printing information on the first print region E1a and the second print region E1b with respect to the cut label in which the boundary mark M1 is printed in advance on the boundaries of respective regions E1, E2, and E3. In this configuration, the cut label before printing on the first print region E1a and the second print region E1b is also included in the scope of the present invention (corresponds to “cable label” of the present invention).

As a further modification example, a configuration in which lengths of respective regions E1, E2, and E3 are allocated and the boundary mark M1 is printed according to the allocated result based on the length (L1) of print region and/or the length (L2) of winding region input by a user, with respect to a fixed-length cut label in which the boundary marks M1 are not printed on the boundaries of respective regions E1, E2, and E3, may be implemented. In this case, as described in the [Modification Example 2], the arrangement of respective regions E1, E2, and E3 may be selectable.

### Modification Example 4

In addition, in the embodiment, although printing is performed on the first print region E1a and the second print region E1b, only one of the regions may be printed. In addition, in the layout selection field 85, it is also possible to select the print regions E1a and E1b to be printed.

### Second Embodiment

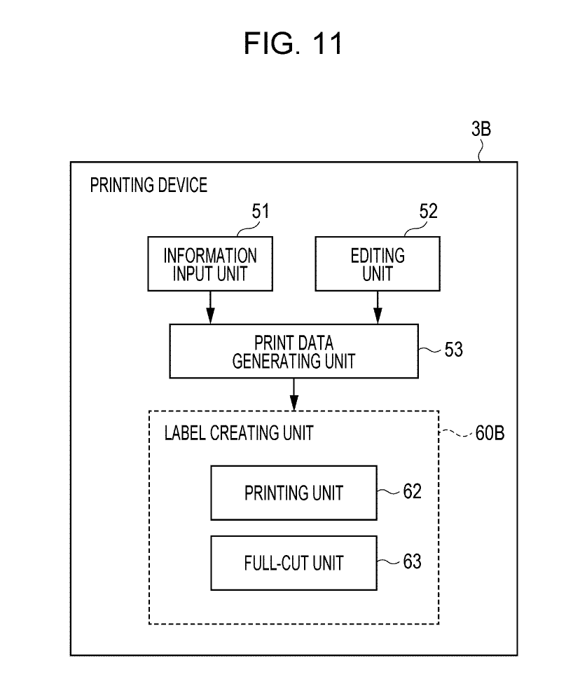

Next, a second embodiment of the present invention will be described with reference to FIG. 11. In the first embodiment, the cable label CL is created in the printing system SY1 by the PC 2 and the printing device 3A. However, in the embodiment, the cable label CL is created by only a printing device 3B including the information input unit and the label creating unit. Hereinafter, in the embodiment, only different points from the first embodiment will be explained. In addition, components similar to those of the first embodiment are denoted by the same reference numerals, and a detailed description thereof will be omitted. In addition, modification examples applied to the same constituent parts as those in the first embodiment are applied to the embodiment as well.

FIG. 11 is a block diagram illustrating a functional configuration of the tape printing device according to the second embodiment. As illustrated in FIG. 11, the printing device 3B as the tape printing device includes the information input unit 51, the editing unit 52, the print data generating unit 53, and a label creating unit 60B. The information input unit 51 and the editing unit 52 perform the information input/edit through operation units (keyboard, touch panel, and the like) (not illustrated) provided in the printing device 3B. In addition, the label creating unit 60B realizes the label creating step in the claims, and includes the printing unit 62 and the full-cut unit 63.

According to the tape printing device of the second embodiment, it is possible to easily create the cable label CL with the printing device 3B alone. Also in the embodiment, as described in [Modification Example 3], the cut label can be applied, and in this case, the full-cut unit 63 can be omitted.

### Third Embodiment

In the embodiment, a case where the label creating method is realized by a personal computer (hereinafter, referred to as “PC”) 2 including the information input unit and a printing device 3C as the label creating unit is exemplified.

A printing system SY2 as the tape printing device of the embodiment includes the PC 2 and the printing device 3C creating a label by performing printing on the elongated print medium (hereinafter, referred to as “printing tape T”) (see FIG. 1). The embodiment is different from the first embodiment in that the cable label CL is created by using the printing device 3C instead of the printing device 3A of the first embodiment. Hereinafter, only the differences from the first embodiment will be described, and similar components are denoted by the same reference numerals, and the detailed description thereof will be omitted.

The printing device 3C in which a tape cartridge 31 accommodating the printing tape T and the ink ribbon is mounted performs the printing process and the cutting process (full-cut process) while feeding the printing tape T from the tape cartridge 31, when the print data is received from the PC 2. The printed portion of the printing tape T is discharged from the tape outlet 32 after the cutting process, and used as the label. The printing device 3C of the embodiment can create the cable label CL used by being wound around an object such as the cable 10 similar to the first embodiment (see FIG. 8A or the like).

Next, with reference to FIG. 12, a hardware configuration of the printing device 3C will be described.

FIG. 12 is a block diagram of the printing device 3C. The printing device 3C includes, as a hardware configuration, the USB communication unit 33, the cartridge detection unit 34, a printing mechanism 35C, and the printing device side control unit 36.

Since the USB communication unit 33 and the cartridge detection unit 34 are the same as those of the first embodiment, description thereof will be omitted.

The printing mechanism 35C includes the printing head 41, the tape feeding motor 42, the full cutter motor 43, the full tape cutter 44, a half cutter motor 45, and a half tape cutter 46.

The full cutter motor 43 drives the full tape cutter 44 to fully cut the printed portion of the printing tape T in the tape width direction in a state of stopping tape feeding temporarily. Although not specifically illustrated, the printing tape T has a structure in which the printing layer and the release paper layer adhere with each other by the adhesive layer. The full tape cutter 44 cuts the printing layer to the release paper layer. Meanwhile, the half cutter motor 45 drives the half tape cutter 46 to fully cut only the release paper layer of the printing tape T in the tape width direction in a state of stopping tape feeding temporarily. Instead of providing the full tape cutter 44 and the half cutter motor 45 separately, full cutting and half cutting may be performed by a common cutter.

The printing device side control unit 36 controls the printing mechanism 35C based on the print data similar to the first embodiment.

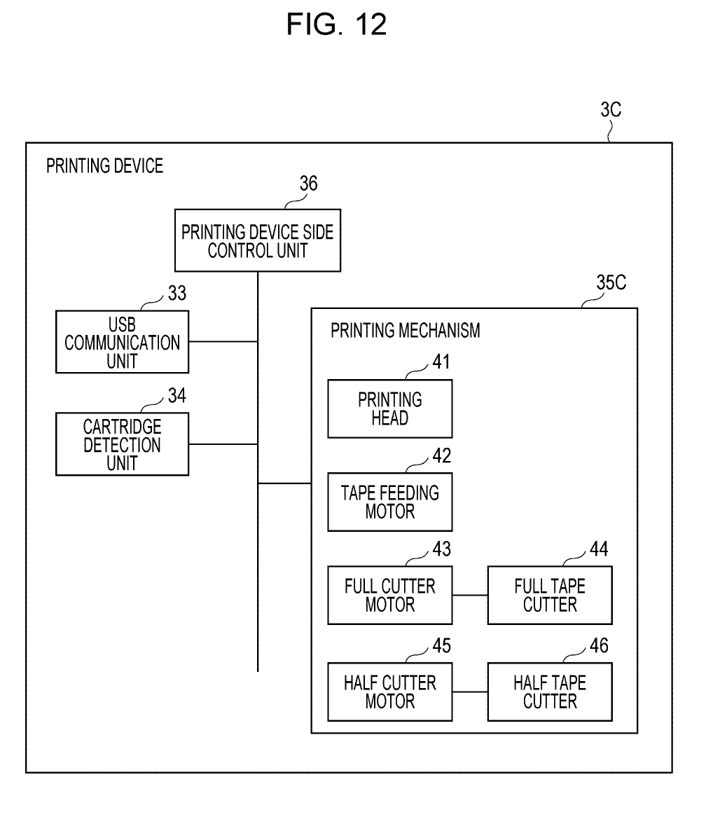

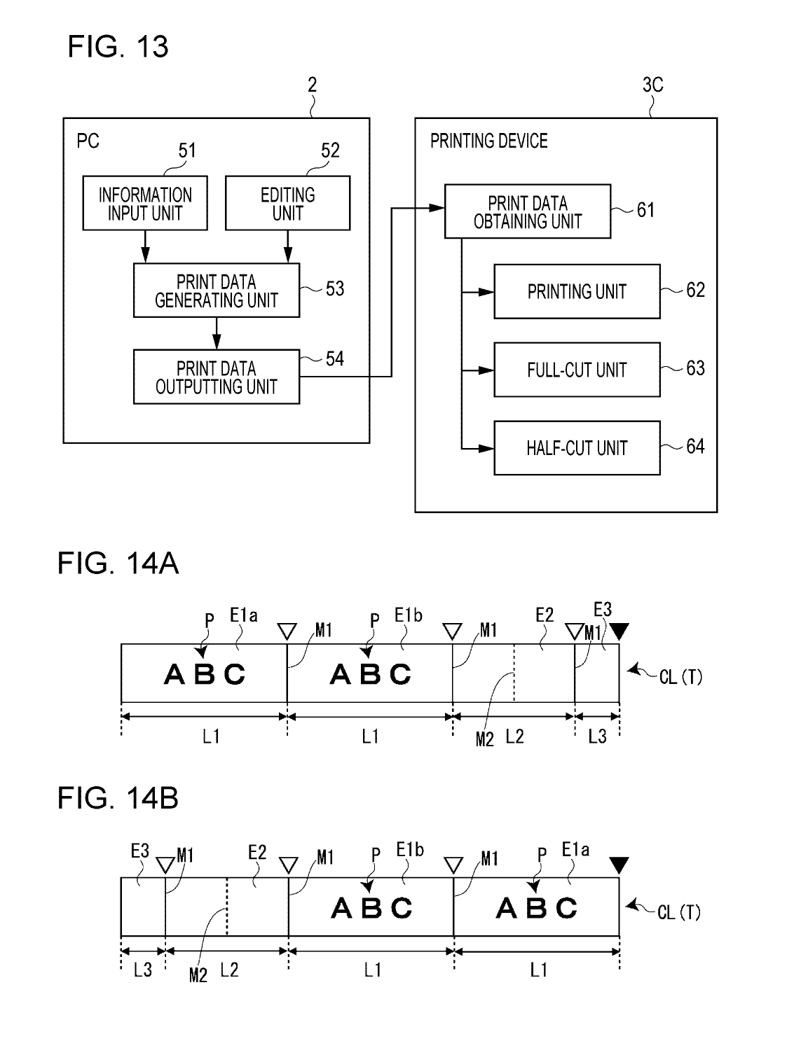

Next, with reference to FIG. 13, a functional configuration of the printing system SY2 will be described. The PC 2 includes, as a functional configuration, the information input unit 51, the editing unit 52, the print data generating unit 53, and the print data outputting unit 54. These are functions provided by mainly the dedicated application 26b (see FIG. 2). In addition, the printing device 3C includes, as a functional configuration, the print data obtaining unit 61, the printing unit 62, the full-cut unit 63, and a half-cut unit 64. The label creating step in the claims is realized by the print data generating unit 53, the print data outputting unit 54, the print data obtaining unit 61, the printing unit 62, the full-cut unit 63, and the half-cut unit 64.

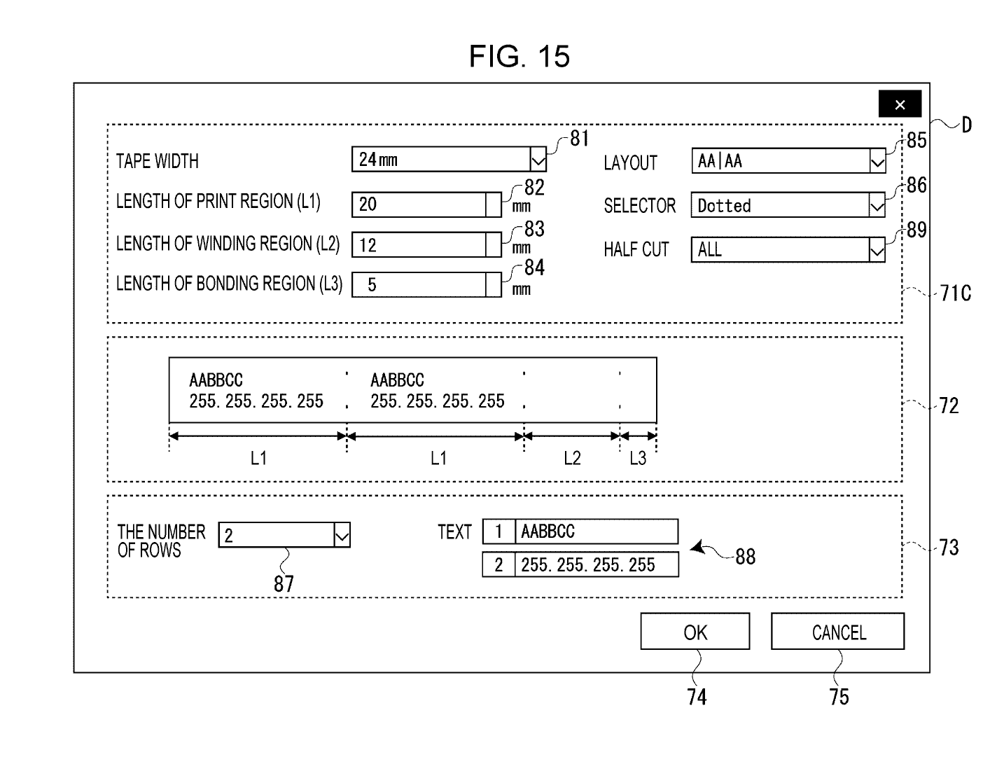

The information input unit 51 receives information (text, image, or the like) to be printed on the print region E1 constituting the flag portion of the cable label CL. In the embodiment, although one or more lines of text as the information are input, an image such as a symbol and a mark may be inserted. The editing unit 52 designates each of the print region E1, the winding region E2, and the length of the sticking region E3. The winding region E2 constitutes the winding margin to be wound around the cable 10. In addition, the sticking region E3 constitutes the adhesion margin that adheres to the flag portion by overlapping or interposing. In addition, the editing unit 52 performs the layout designation of the print region E1, the selection of the boundary marks M1 (selector) indicating the boundaries of the respective regions E1, E2, and E3, selection of half-cut position, or the like (see edit region 71C of FIG. 15).

The print data generating unit 53 generates the print data for creating the cable label CL. The print data includes the instruction for printing information input by the information input unit 51 on the print region E1 (first print region E1a and/or second print region E1b), the instruction for printing the boundary marks M1 on boundaries of respective regions E1, E2, and E3 based on the designation of the editing unit 52, an instruction for performing half cutting the boundaries on respective regions E1, E2, and E3, an instruction for performing full cutting on the rear end of the cable label CL, or the like. The print data outputting unit 54 outputs the print data generated by the print data generating unit 53 to the printing device 3C.

Here, a configuration (arrangement of respective regions E1, E2, and E3) of the cable label CL will be described. FIG. 14A is a diagram illustrating a created example of the cable label CL according to the embodiment.

The cable label CL of FIG. 14A is the label of the label length (2L1+L2+L3) including the first print region E1a having the length L1 and the second print region E1b having the length L1 which are adjacent to each other in the longitudinal direction of the printing tape T, the winding region E2 having the length L2 adjacent to the second print region E1b, and the sticking region E3 having the length L3 adjacent to the winding region E2.

“Adjacent” means that they are adjacent to each other, that is, there is no other region between them. In addition, on the printing layer of the first print region E1a and the second print region E1b, the print image P (text “ABC” in example of FIG. 14A) is printed based on the information input by the information input unit 51, and on the boundaries of respective regions E1, E2, and E3, the boundary marks M1 (in example of FIG. 14A, solid line extending in width direction of printing tape T) are printed.

Furthermore, on the central portion of the winding region E2 in the longitudinal direction, the reference mark M2 (in example of FIG. 14A, dotted line extending in width direction of printing tape T) which is the reference position at the time of winding the winding region E2 around the cable 10 is printed.

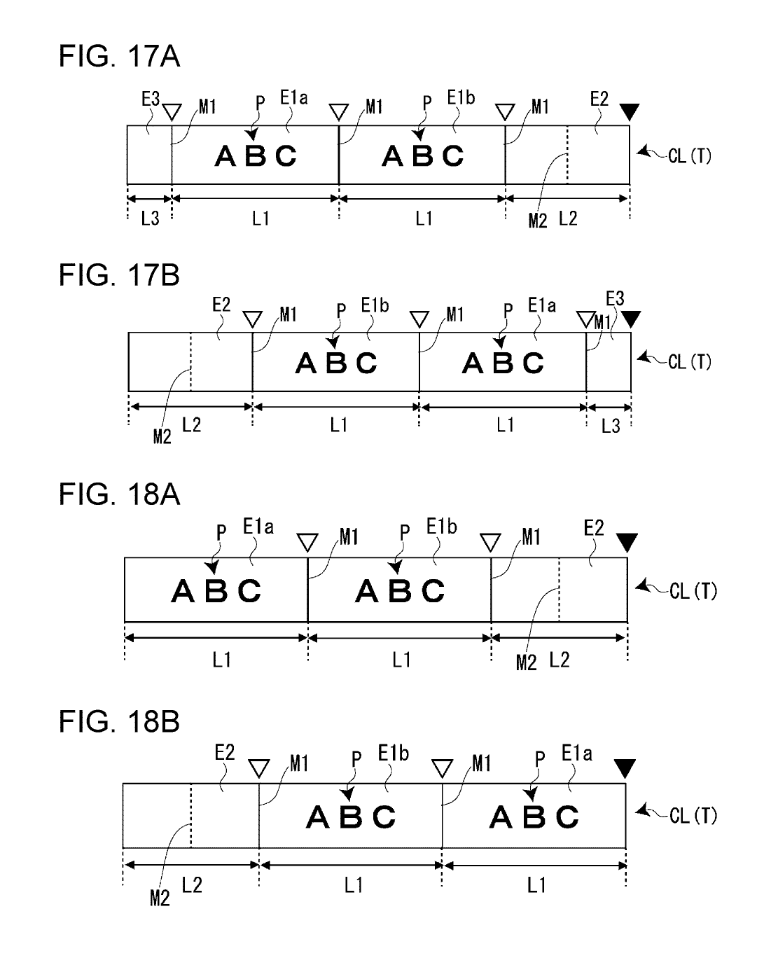

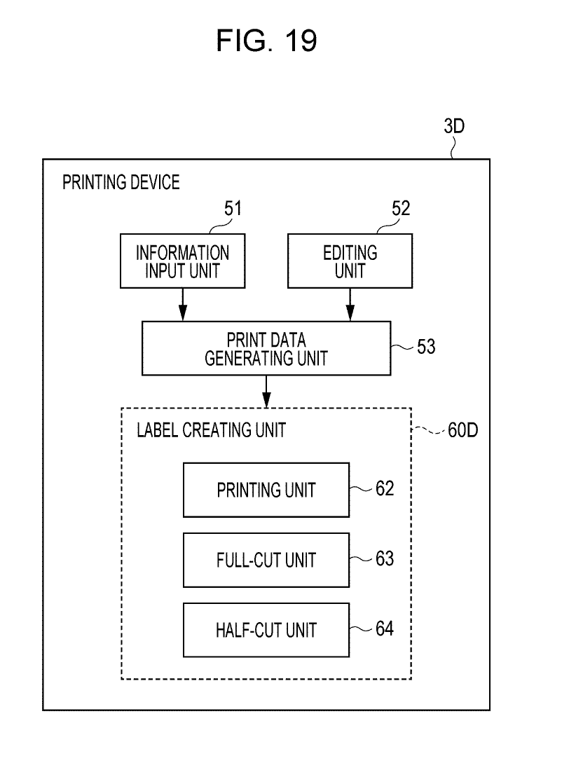

On the other hand, in FIG. 14A, a white inverted triangular mark indicates a half-cut position, and a black inverted triangular mark indicates a full-cut position (these marks are also the same in FIG. 14B, FIG. 17A, FIG. 17B, FIG. 18A, and FIG. 18B). That is, boundary positions of respective regions E1, E2, and E3 cut only the release paper layer in the width direction (in case where half-cut position “all” is selected in half cut selection field 89 which will be described below). In addition, both the printing layer and the release paper layer are cut at a rear end of the tape.

The arrangement of respective regions E1, E2, and E3 of the cable label CL is not limited to the arrangement illustrated in FIG. 14A, and as illustrated in FIG. 14B, respective regions E1, E2, and E3 of FIG. 14A may be symmetrically arranged. That is, a configuration in which respective regions are provided adjacent to each other in the longitudinal direction of the printing tape T in the order of the print region E1, the winding region E2, and the sticking region E3 may be implemented.

Returning to the description of FIG. 13. The print data obtaining unit 61 of the printing device 3C obtains the print data from the PC 2. The printing unit 62 performs printing on the printing tape T based on the obtained print data. That is, the print image P, the boundary mark M1, and the reference mark M2 are printed on positions designated within each print data. In addition, the full-cut unit 63 cuts the printing layer and the release paper layer of the printing tape T in the width direction based on the obtained print data (to be length of label that is designated). In addition, the half-cut unit 64 cuts the boundaries of respective regions E1, E2, and E3 in the width direction in the release paper layer of the printing tape T based on the obtained print data.

Next, with reference to FIG. 15, a screen configuration of the label edit screen D will be described. The label edit screen D includes an edit region 71C, the preview display region 72, the information input region 73, the OK button 74, and the cancel button 75. When the OK button 74 is selected, the edit content of the label edit screen D is reflected on the print data. In addition, when the cancel button 75 is selected, the edit content of the label edit screen D becomes invalid. A configuration in which the print data is output to the printing device 3C by selecting the OK button 74, may be implemented.

The edit region 71C includes the tape width selection field 81, the print region length selection field 82, the winding region length selection field 83, the sticking region length selection field 84, the layout selection field 85, the selector selection field 86, and the half cut selection field 89.

Since the tape width selection field 81, the print region length selection field 82, the winding region length selection field 83, the sticking region length selection field 84, the layout selection field 85, and the selector selection field 86 are the same as those of the first embodiment, description thereof is omitted.

The half cut selection field 89 is used for selecting the half-cut position. In the embodiment, as the half-cut position, one of “one place”, “two places”, “all”, and “no half cut” can be selected. For example, in a case where “one place” is selected, the half cutting is performed between the print region E1 and the winding region E2. In addition, in a case where “two places” is selected, the half cutting is performed between the print region E1 and the winding region E2, and between the first print region E1a and the second print region E1b. In addition, in a case where “all” is selected, the half cutting is performed between the print region E1 and the winding region E2, between the first print region E1a and the second print region E1b, between and the winding region E2 and the sticking region E3. Furthermore, in a case where “no half cut” is selected, the half cutting is not performed.

A label image on which an edit/input result of the edit region 71C and the information input region 73 is reflected is displayed on the preview display region 72. In addition, “L1”, “L2”, and “L3” indicate lengths of respective regions E1, E2, and E3, and correspond to symbols displayed on each field of the print region length selection field 82, the winding region length selection field 83, and the sticking region length selection field 84.

The information input region 73 includes the number of rows selection field 87 for selecting an input row of a text and the text input field 88 for inputting a text corresponding to each row. A row input field of the number of rows selected in the number of rows selection field 87 is displayed in the text input field 88. A text that is input in the text input field 88 is reflected on the label image of the preview display region 72 according to the input. In the tape width selection field 81 to the sticking region length selection field 84 in the edit region 71C, and the number of rows selection field 87 of the information input region 73, each edit item is designated by selecting a desired option from a plurality of options, but a numerical value may be directly input.

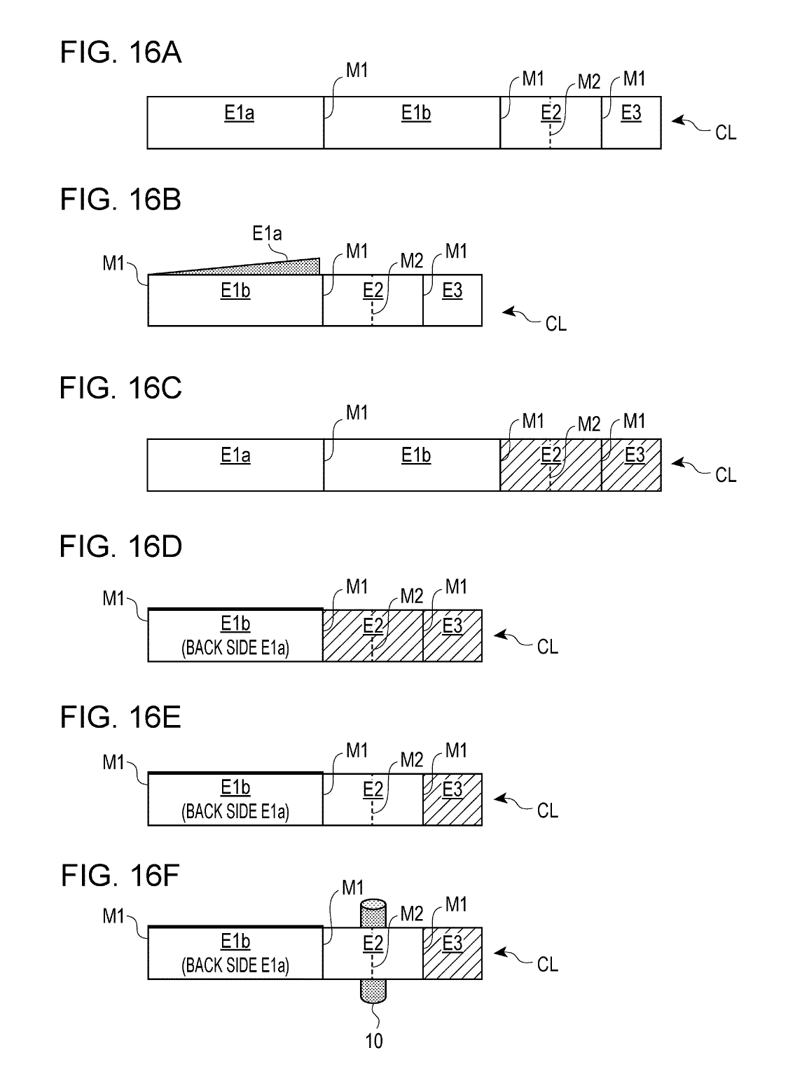

Next, with reference to FIG. 16A to FIG. 16F, a procedure for attaching the cable label CL to the cable 10 will be described. Here, it is assumed that the half-cut position “all” is selected in the half cut selection field 89.

FIG. 16A illustrates the cable label CL in a state of being discharged from the printing device 3C. From this state, as illustrated in FIG. 16B, the folding (folding operation) is performed by folding along the boundary mark M1 between the first print region E1a and the second print region E1b. In this procedure, since the half cutting is performed between the first print region E1a and the second print region E1b, it is possible to easily attach the folding portion. Subsequently, as illustrated in FIG. 16C, the release paper of the print region E1 is peeled off. Shaded regions (in FIG. 16C, winding region E2 and sticking region E3) indicate that the release paper remains (these regions are also the same in FIG. 16D, FIG. 16E, and FIG. 16F).

Subsequently, as illustrated in FIG. 16D, the folding portion in FIG. 16B is folded such that the adhesive layers of the first print region E1a and the second print region E1b are bonded. Thus, as illustrated in FIG. 16E, the release paper of the winding region E2 is peed off, and as illustrated in FIG. 16F, the winding position on the cable 10 is determined with the reference mark M2 of the winding region E2 as a reference. In a state of FIG. 16F, by peeling off the release paper of the sticking region E3 and by adhering the sticking region E3 to be overlapped on the first print region E1a (see FIG. 8A), the attachment of the cable label CL is completed.

As described above, since the half cutting is performed on the boundary of the print region E1 and the winding region E2, the cable label CL created by the printing system SY2 of the embodiment can create the flag portion by bonding the first print region E1a and the second print region E1b in advance before going to the site. With this, since it is only necessary to wind the winding region E2 around the cable 10 in the site, it is possible to greatly reduce a work burden.

In addition, since the cable label CL of the embodiment includes the sticking region E3 that adheres to the print region E1 by overlapping or interposing, there is a merit that it is much less likely to be peeled off as compared with a label not having the sticking region E3. In addition, since the first print region E1a and the second print region E1b which become the flag portion are provided adjacent to each other, there is also a merit that the user can easily attach the flag portion.

In addition, by performing the half cutting between the first print region E1a and the second print region E1b, it is possible to easily perform the folding operation before performing bonding of the flag portion. Furthermore, by performing the half cutting between the winding region E2 and the sticking region E3, since it is possible to wind a winding margin around the cable 10 while leaving the release paper of a bonding margin, it is possible to make it more difficult for the cable label CL to peel off without weakening adhesive strength of the bonding margin.

In addition, since the boundary marks M1 are printed on the boundaries of respective regions E1, E2, and E3, and the reference mark M2 is printed on the central portion of the winding region E2, the user can grasp the bending position of the flag portion and an attachment position on the cable 10. Furthermore, in the label edit screen D, since lengths (L1, L2, and L3) of the print region E1, the winding region E2, and the sticking region E3 can be designated, the length of each of the regions E1, E2, and E3 can be arbitrarily set according to the thickness of the cable, the number of cables, the user's preference, and the like.

Regardless of the above embodiments, the following modification examples can be adopted. In addition, modification examples applied to the same constituent parts as those in the above embodiments are also applied to the embodiment as well.

### Modification Example 5

In addition, as illustrated in FIGS. 14A and 14B, in the embodiment, the cable label CL connected in the order of the print region E1, the winding region E2, and the sticking region E3 is created. However, as illustrated in FIG. 17A, the cable label CL connected in an order of the sticking region E3, the print region E1 (first print region E1a+second print region E1b), and the winding region E2 may be created. In addition, as illustrated in FIG. 17B, respective regions E3, E1, and E2 of FIG. 17A may be symmetrically arranged. In these cases, the sticking region E3 is bonded by being overlapped on the winding region E2.

In addition, as a further modification example, the user may be able to select a desired arrangement from the arrangement of FIG. 14A, the arrangement of FIG. 14B, the arrangement of FIG. 17A, and the arrangement of FIG. 17B. According to the configuration, the arrangements of respective regions E1, E2, and E3 can be arbitrarily selected according to the preference and usage of the user.

### Modification Example 6

In addition, in the embodiment, the cable label CL including the print region E1, the winding region E2, and the sticking region E3 is created. However, as illustrated in FIGS. 18A and 18B, the sticking region E3 may be omitted. In this case, the full-cut unit 63 (label creating step) performs the full cutting so that a label length of the cable label CL becomes (2L1+L2). In this case, in the half cut selection field 89, as the half-cut position, one of “one place”, “two places”, “all”, and “no half-cut” can be selected.

In addition, as a further modification example, a bonding margin selection field (not illustrated) for selecting the presence or absence of the bonding margin is provided in the edit region 71C, and thus the cable label CL may be created according to a selected result of the selection field. According to the configuration, it is possible to select the presence or absence of the bonding margin according to the preference and usage of the user.

### Modification Example 7

In addition, in the embodiment, although the cable label CL is created by cutting the elongated printing tape T, the cut label (strip-shaped print medium) which does not require the cutting may be used. That is, in a configuration of the printing device 3C illustrated in FIG. 13, the full-cut unit 63, and the half-cut unit 64 may be omitted. The cut label means the printing tape T in which a fixed-length label having the first print region E1a, the second print region E1b, the winding region E2, and the sticking region E3 in advance is formed.

In this case, with respect to the cut label in which the boundary marks M1 are printed in advance on the boundaries of respective regions E1, E2, and E3, and the half cutting is performed in advance on the boundaries of respective regions E1, E2, and E3, the cable label CL is created by printing information on the first print region E1a, and the second print region E1b. In the configuration, the cut label before printing on the first print region E1a and the second print region E1b is also included in the scope of the present invention (this corresponds to “cable label” in present invention).

As a further modification example, a configuration in which the lengths of respective regions E1, E2, and E3 based on the length (L1) of the print region and/or the length (L2) of the winding region that are input by the user are allocated with respect to a fixed-length cut label in which printing of the boundary marks M1 and the half cutting are not performed, and the printing of the boundary marks M1 and the half cutting are performed according to the allocated result, may be implemented. In this case, as described in the [Modification Example 5], the arrangements of respective regions E1, E2, and E3 may be selectable.

In addition, as a further modification example, by combining the [Modification Example 6] and the [Modification Example 7], the cut label in which the printing of the boundary marks M1 and the half cutting is performed in advance between the print region E1 and the winding region E2 may be used. In addition, by performing the printing of the boundary marks M1 and the half cutting on the fixed-length cut label, the cable label CL including the print region E1 and the winding region E2 may be created.

### Modification Example 8

In addition, in the embodiment, although the boundary marks M1 are printed on the boundaries of respective regions E1, E2, and E3, the printing of the boundary marks M1 may be omitted. In addition, based on a selected result in the half cut selection field 89, the boundary mark M1 may be printed on a boundary portion, as a target, on which the half cutting is not performed. For example, in a case where “one place” is selected as the half-cut position, since the half cutting is performed between the print region E1 and the winding region E2, the boundary marks M1 may be printed between the first print region E1a and the second print region E1b, and between the winding region E2 and the sticking region E3.

### Fourth Embodiment

Next, with reference to FIG. 19, a fourth embodiment of the present invention will be described. In the third embodiment, the cable label CL is created in the printing system SY2 by the PC 2 and a printing device 3D. However, in the embodiment, the cable label CL is created by only the printing device 3D including the information input unit and the label creating unit. Hereinafter, in the embodiment, only points different from the third embodiment will be explained. In addition, the same reference numerals are given to the same constituent parts as those of the third embodiment, and a detailed description thereof will be omitted. Also, the modification example applied to the same constituent parts as in the third embodiment is similarly applied to the embodiment.

FIG. 19 is a block diagram illustrating a functional configuration of the printing device 3D according to a fourth embodiment. As illustrated in FIG. 19, the printing device 3D as the tape printing device includes the information input unit 51, the editing unit 52, the print data generating unit 53, and a label creating unit 60D. The information input unit 51 and the editing unit 52 perform the information input/edit through operation units (keyboard, touch panel, and the like) (not illustrated) provided in the printing device 3D. In addition, the label creating unit 60D realizes the label creating step in the claims, and includes the printing unit 62, the full-cut unit 63, and the half-cut unit 64.

According to the tape printing device of a fourth embodiment, it is possible to easily create the cable label CL with the printing device 3D alone. Also in the embodiment, as described in [Modification Example 7], the cut label can be applied, and in this case, the full-cut unit 63 and the half-cut unit 64 can be omitted.

So far, embodiments of the present invention, and modification examples are described, but it is also possible to provide each of the constituent elements in the printing systems SY1 and SY2 (PC 2), or the printing devices 3A, 3B, 3C, and 3D described in these embodiments and examples as a program. In addition, the program may be provided by being stored in various recording media (CD-ROM, flash memory, or the like). That is, a program for causing a computer to function as the respective components of the printing systems SY1 and SY2, or the printing devices 3A, 3B, 3C, and 3D, a recording medium in which the program is recorded, and the cable label CL created by the program are also included in the scope of the present invention. In addition, instead of the PC 2 of the embodiments, it is possible to appropriately change embodiments without departing from the gist of the present invention such as other information processing terminals of a tablet terminal or the like are used and each part of the PC 2 is realized by cloud computing.

### REFERENCE SIGNS LIST

2: PC
3A, 3B, 3C, 3D: printing device
26b: dedicated application
51: information input unit
52: editing unit
53: print data generating unit
54: print data outputting unit
60B, 60D: label creating unit
61: print data obtaining unit
62: printing unit
63: full-cut unit
71A, 71C: edit region
72: preview display region
73: information input region
CL: cable label
D: label edit screen
E1: print region
E1a: first print region
E1b: second print region
E2: winding region
E3: sticking region
M1: boundary mark
M2: reference mark
P: print image
SY1, SY2: printing system
T: printing tape

### CROSS REFERENCE TO RELATED APPLICATIONS

This application is a National Stage Entry of International Application No. PCT/JP2016/000538, filed Feb. 3, 2016; which claims priority to Japanese Patent Application Nos. 2015-049916 and 2015-049917, filed on Mar. 12, 2015; the entire contents of all of which are incorporated by reference herein.

1. A label creating method comprising:
an information inputting step of inputting information; and
a label creating step of printing the information that is input in the information inputting step on at least one of a first print region having a length L1 and a second print region having the length L1 adjacent to an elongated or strip-shaped print medium in a longitudinal direction, and of creating a cable label including a print region including the first print region and the second print region, a winding region having a length L2 adjacent to the print region in the longitudinal direction, and a sticking region having a length L3 adjacent to the winding region or the print region in the longitudinal direction.

2. The label creating method according to claim 1, further comprising:
an editing step of designating each of lengths of the length L1, the length L2, and the length L3,
wherein in the label creating step, the print medium is cut to be a label length (2L1+L2+L3) of the cable label.

3. The label creating method according to claim 1,
wherein in the label creating step, the length L3 is variably set according to a tape width of the print medium.

4. The label creating method according to claim 2,
wherein in the label creating step, each boundary mark is printed on boundaries of the first print region, the second print region, the winding region, and the sticking region.

5. The label creating method according to claim 1, further comprising:
an arrangement selecting step of selecting arrangements of the print region, the winding region, and the sticking region from a plurality of options,
wherein in the label creating step, the cable label is created based on a selected result of the arrangement selecting step.

6. A label creating method comprising:
an information inputting step of inputting information; and
a label creating step of printing information that is input in the information inputting step on at least one of a first print region having a length L1 and a second print region having the length L1 adjacent to an elongated or strip-shaped print medium in which a printing layer and a release paper layer adhere to each other in a longitudinal direction, and of creating a cable label including a print region including the first print region and the second print region, and a winding region having a length L2 adjacent to the print region in the longitudinal direction,
wherein in the label creating step, half cutting for cutting a boundary between the print region and the winding region in the release paper layer in a width direction is performed.

7. The label creating method according to claim 6, further comprising:
an editing step of designating each of lengths of the length L1 and the length L2,
wherein in the label creating step, full cutting for cutting the printing layer and the release paper layer in the width direction to be a label length (2L1+L2) of the cable label is performed.

8. The label creating method according to claim 6,
wherein in the label creating step, half cutting for cutting a boundary between the first print region and the second print region in the release paper layer in the width direction is performed.

9. The label creating method according to claim 6,
wherein in the label creating step, the cable label having the sticking region of a length L3 adjacent to the winding region or the print region in the longitudinal direction is created.

10. The label creating method according to claim 9, further comprising:
an editing step of designating each of lengths of the length L1, the length L2, and the length L3,
wherein in the label creating step, the full cutting for cutting the printing layer and the release paper layer in the width direction to be a label length (2L1+L2+L3) of the cable label is performed.

11. The label creating method according to claim 9,
wherein in the label creating step, half cutting for cutting a boundary between the sticking region and the print region or the winding region in the release paper layer in the width direction is performed.

12. A program causing a computer to execute:
an information inputting step of inputting information; and
a print data generating step of printing the information that is input in the information inputting step on at least one of a first print region having a length L1 and a second print region having the length L1 adjacent to an elongated or strip-shaped print medium in a longitudinal direction, and of generating print data to create a cable label including a print region including the first print region and the second print region, a winding region having a length L2 adjacent to the print region in the longitudinal direction, and a sticking region having a length L3 adjacent to the winding region or the print region in the longitudinal direction.

13. A program causing a computer to execute:
an information inputting step of inputting information, and
a print data generating step of printing the information that is input in the information inputting step on at least one of a first print region having a length L1 and a second print region having the length L1 adjacent to an elongated or strip-shaped print medium in which a printing layer and a release paper layer adhere to each other in a longitudinal direction, and of generating print data to create a cable label including a print region including the first print region and the second print region, and a winding region having a length L2 adjacent to the print region in the longitudinal direction,
wherein the print data includes a half cutting instruction for cutting a boundary between the print region and the winding region in the release paper layer in the width direction.

14. A tape printing device comprising:
an information input unit that receives information; and
a label creating unit that prints the information that is input by the information input unit on at least one of a first print region having a length L1 and a second print region having the length L1 adjacent to an elongated or strip-shaped print medium in a longitudinal direction, and that creates a cable label including a print region including the first print region and the second print region, a winding region having a length L2 adjacent to the print region in the longitudinal direction, and a sticking region having a length L3 adjacent to the winding region or the print region in the longitudinal direction.

15. A tape printing device comprising:
an information input unit that receives information; and
a label creating unit that prints the information that is input by the information input unit on at least one of a first print region having a length L1 and a second print region having the length L1 adjacent to an elongated or strip-shaped print medium in which a printing layer and a release paper layer adhere to each other in a longitudinal direction, and that creates a cable label including a print region including the first print region and the second print region, and a winding region having a length L2 adjacent to the print region in the longitudinal direction,
wherein the label creating unit performs half cutting for cutting a boundary between the print region and the winding region in the release paper layer in the width direction.

16. A cable label comprising:
a print region including a first print region having a length L1 and a second print region having the length L1 adjacent to an elongated or strip-shaped print medium in which a printing layer and a release paper layer adhere to each other in a longitudinal direction;
a winding region having a length L2 adjacent to the print region in the longitudinal direction; and
a sticking region having a length L3 adjacent to the winding region or the print region in the longitudinal direction,
wherein boundary marks indicating boundaries of the first print region, the second print region, the winding region, and the sticking region are printed.

17. A cable label comprising:
a print region including a first print region having a length L1 and a second print region having the length L1 adjacent to an elongated or strip-shaped print medium in which a printing layer and a release paper layer adhere to each other in a longitudinal direction; and
a winding region having a length L2 adjacent to the print region in the longitudinal direction,
wherein a boundary between the print region and the winding region in the release paper layer is cut in the width direction.
